(19) United States
(12) Patent Application Publication
(10) Pub. No.: US 2026/0208960 A1
(43) Pub. Date: Jul. 23, 2026

(54) TRANSFER UNIT, TRANSFER ASSEMBLY AND TRANSFER ARRANGEMENT

(71) Applicant: AVANCON SA, Riazzino (CH)

(72) Inventor: Daniele GAMBETTA, Giubiasco (CH)

(21) Appl. No.: 19/138,414

(22) PCT Filed: Dec. 14, 2022
(86) PCT No.: PCT/EP2022/085968

§ 371 Date: Jun. 12, 2025

(51) Int. Cl. B65G 13/10; B65G 13/02

(52) U.S. Cl. CPC B65G 13/10; B65G 13/02

(57) ABSTRACT

A transfer unit (1) comprising a roller unit (10) with driven rollers (103; 104) that are mounted on a retaining bracket (101) that is rotatable about a vertical axis (Z), an orientation transmission unit (11) with which the rotation of the retaining bracket (101) can be affected, a rotation transmission unit (12) with which the rotation of the driven rollers (103; 104) can be affected, and a drive unit (13) with a drive shaft (131), wherein the drive shaft (131) is operatively connected to the driven rollers (103; 104) for enabling their rotation or wherein the drive shaft is operatively connected to the retaining bracket (101) for enabling the adjustment of the orientation of the driven rollers (103; 104).

### TECHNICAL FIELD OF THE INVENTION

The current invention relates to transfer units for conveying systems which can be combined to transfer assemblies and transfer arrangements.

### DESCRIPTION OF THE RELATED ART

A known embodiment of such a transfer unit is disclosed in EP 3 105 152 B1. It has driven rollers that are mounted on a bracket that is rotatable about a vertical axis. The orientation of the bracket is adjustable by a rack that is driven by a separate drive. The rotation of the rollers is realized by belt that is driven by a separate drive. Such a design requires space next to the transfer unit for the separate drives. As this space is often not available, elaborate design adjustments must be made to the adjoining elements.

### SUMMARY OF THE INVENTION

It is a task of current invention to provide a more compact transfer unit that requires less space.

This task is solved by a transfer unit with the features of claim 1. Further embodiments of the transfer unit, a transfer assembly, as well as a transfer arrangement are defined by the features of further claims.

A transfer unit according to the invention comprises a roller unit with at least one driven roller that is mounted rotatably about a horizontal axis on a retaining bracket, an orientation transmission unit with a housing, in which the retaining bracket is arranged rotatably about a vertical axis, a rotation transmission unit with a housing, in which a transmission shaft is arranged rotatably about the vertical axis, at an upper end of which transmission shaft a bevel wheel is fixed. The orientation transmission unit is stacked above the rotation transmission unit, and the bevel wheel engages the at least one driven roller. The transfer unit comprises a drive unit with a housing, in which a drive shaft is arranged rotatably about the vertical axis. The rotation transmission unit is stacked above the drive unit and the drive shaft is operatively connected to the transmission shaft for enabling the driving of the at least one driven roller. Alternatively, the drive shaft is operatively connected to the retaining bracket for enabling the adjustment of the orientation of the at least one driven roller.

This design has the advantage that the drive for rotating the at least one driven roller or for rotating the retaining bracket is integrated into the transfer unit, whereby the required space of the transfer unit is reduced.

In one embodiment, a first transfer unit comprises a first roller unit, which is stacked above a first orientation transmission unit, which is stacked above a first rotation transmission unit, which is stacked above a first drive unit. A first drive shaft of the first drive unit is directly coupled to a first transmission shaft of the first rotation transmission unit. A first pulley is arranged in the housing of the first rotation transmission unit and is fixed to the first transmission shaft.

In one embodiment, a second transfer unit comprises a second roller unit, which is stacked above a second orientation transmission unit, which is stacked above a second rotation transmission unit, which is stacked above a second drive unit. A second drive shaft of the second drive unit is coupled to the retaining bracket of the second roller unit by a first spur wheel, an offset shaft and a second spur wheel reaching from the second orientation transmission unit into the second rotation transmission unit. A second pulley is arranged in the housing of the second rotation transmission unit and is fixed to a second transmission shaft.

Since it is favorable to have identical parts, the second drive shaft can be identical to the first drive shaft. It is also possible to provide a first drive unit and a second drive unit, whose coils, cores, and bearing are identical.

In one embodiment, the at least one driven roller comprises a helical gearing that engages the bevel wheel. It is advantageous when the at least one driven roller comprises an inner part that comprises the helical gearing and a sleeve that is mounted around the inner part. The inner part may be made from a first material, such as metal and the sleeve may be made from a second material, such as plastic.

In one embodiment, a first driven roller and a second driven roller are arranged on a horizontal roller shaft, wherein the first driven roller comprises the helical gearing and wherein the second driven roller has no gearing.

In one embodiment, the first driven roller and the second driven roller are fixed to the roller shaft. Alternatively, they are foxed to one another.

The second driven roller may be made from the same material as the sleeve of the first driven roller.

In one embodiment, the retaining bracket comprises a cylindrical base that extends along the vertical axis and two arms that are attached to the cylindrical base and that extend in the direction of the vertical axis on two opposing lateral sides of the cylindrical base.

In one embodiment, the cylindrical base comprises a spur gearing at its circumference, with which a rack can engage.

In one embodiment, the roller shaft is mounted on the two arms with roller shaft bearings.

In one embodiment, a roller unit housing laterally encloses the retaining bracket and a part of the at least one driven roller protrudes from the roller unit housing. A disc-shaped cover is arranged rotatably around the vertical axis around the at least one driven roller and is flush with a top surface of the roller unit housing.

In one embodiment, at least one recess is arranged in first lateral walls and wherein a corresponding number of thereto complementary projections are arranged on second lateral walls that are arranged opposite to the first lateral walls.

In one embodiment, the housing of the orientation transmission unit comprises a first bore in which an upper part of the cylindrical base of the retaining bracket is rotatably arranged. The housing of the rotation transmission unit comprises a second bore in which a lower part of the cylindrical base of the retaining bracket (101) is rotatably arranged.

The features of the above-mentioned embodiments of the transfer unit can be used in any combination, unless they contradict each other.

A transfer assembly according to the invention comprises one first transfer unit according to the invention, one second transfer unit according to the invention and at least one third transfer unit, wherein the first transfer unit is arranged on a first lateral side of the at least one third transfer unit and wherein the second transfer unit is arranged on a second lateral side of the at least one third transfer unit, opposite to the first lateral side. Alternatively, A transfer assembly according to the invention comprises one first transfer unit according to the invention, at least one third transfer unit and one separate drive unit, wherein the first transfer unit is arranged on a first lateral side of the at least one third transfer unit and wherein the separate drive unit is arranged on a second lateral side of the at least one third transfer unit, opposite to the first lateral side. Alternatively, the separate drive unit is arranged on a side of the first transfer unit, opposite to the at least one third transfer unit. The third transfer unit comprises a third roller unit, which is stacked above a third orientation transmission unit, which is stacked above a third rotation transmission unit. A third pulley and a fourth pulley are arranged in a housing of the third rotation transmission unit and are fixed to a third transmission shaft. The separate drive unit comprises a fourth orientation transmission unit, which is stacked above a spacer unit, which is stacked above a third drive unit. The spacer unit comprises a housing, in which a fourth transmission shaft is arranged rotatably about the vertical axis, at an upper end of which fourth transmission shaft a third spur wheel is fixed. A third drive shaft of the third drive unit is directly coupled to the fourth transmission shaft of the spacer unit. A first belt is wrapped around the first pulley of the first transfer unit and around the third pulley of the third transfer unit. Alternatively, the first belt is wrapped around the second pulley of the second transfer unit and around the third pulley of the third transfer unit. A second belt is wrapped around the fourth pulley of two neighboring third transfer units. A common rack is arranged linearly movable in the first orientation transmission unit of the first transfer unit, the second orientation transmission unit of the second transfer unit and the third orientation transmission unit of the third transfer unit. Alternatively, the common rack is arranged linearly movable in the first orientation transmission unit of the first transfer unit, the third orientation transmission unit of the third transfer unit and the fourth orientation transfer unit of the separate drive unit.

It is possible to provide a third drive shaft that is identical to the first drive shaft. To reduce the number of different parts, the coils, cores, and bearing of the third drive unit, can be identical to those of the first drive unit. Also, the first roller unit, the second roller unit and the third roller unit can be identical. The first orientation transmission unit and the third orientation transmission unit can be identical as well. The housings of the first rotation transmission unit and the spacer unit can be identical and the housings of the first drive unit, the second drive unit and the third drive unit can be identical.

In one embodiment, the common rack comprises several identical rack parts that are connected to one another in a single line, wherein each rack part has a length of one transfer unit in the direction of the linear movement of the common rack.

A transfer arrangement according to the invention comprises at least two transfer assemblies according to an above-mentioned embodiment which are arranged next to each other in a first horizontal direction or in a first horizontal direction and a second horizontal direction, perpendicular to the first horizontal direction.

### BRIEF DESCRIPTION OF THE DRAWINGS

Embodiments of the current invention are described in more detail in the following with reference to the figures. These are for illustrative purposes only and are not to be construed as limiting. It shows

FIG. 1 a sectional view of a first transfer unit according to the invention;

FIG. 2 a sectional view of a second transfer unit according to the invention;

FIG. 3 a sectional view of a third transfer unit according to the invention;

FIG. 4 a top view of the first transfer unit, the second transfer unit and the third transfer unit;

FIG. 5 sectional view of a separate drive unit;

FIG. 6 a perspective view of a first embodiment of a transfer assembly according to the invention; and

FIG. 7 a perspective view of a second embodiment of a transfer assembly according to the invention.

### DETAILED DESCRIPTION OF THE INVENTION

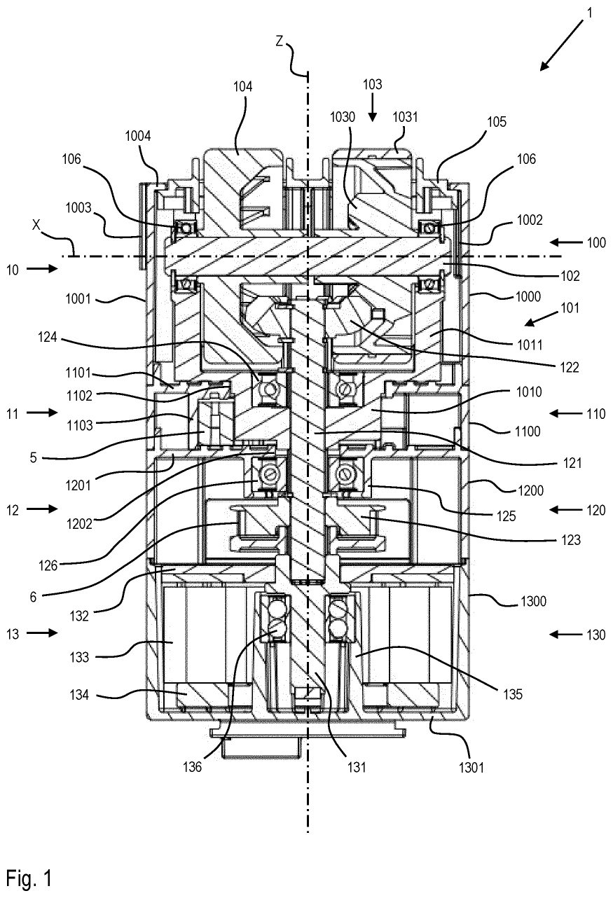

FIG. 1 shows a sectional view of a first transfer unit 1 according to the invention. It comprises a first roller unit 10, that is stacked atop a first orientation transmission unit 11, that is stacked atop a first rotation transmission unit 12, that is stacked atop a first drive unit 13. The first drive unit 10 comprises a housing 100 with first lateral walls 1000 and with thereto opposite second lateral walls 1001, wherein recesses 1002 are provided in the first lateral walls 1000 and wherein thereto complementary projections 1003 are provided in the second lateral walls 1001. At the top, the housing 100 is defined by a top plate 1004. A retaining bracket 101 is arranged in the housing 100, rotatably about a vertical axis Z. The retaining bracket 101 comprises a cylindrical base 1010 that extends along the vertical axis Z and two arms 1011 that are attached to the cylindrical base 1010 and that extend in the direction of the vertical axis Z on two opposing lateral sides of the cylindrical base 1010. The cylindrical base 1010 comprises an upper part, a middle part with a spur gearing at its circumference, with which a rack 5 is engaged and a lower part. A roller shaft 102 is mounted on the two arms 1011 with roller shaft bearings 106. The roller shaft 102 is rotatable about a horizontal axis X. One first driven roller 103 and a second driven roller 104 are fixed to the roller shaft 102, symmetrically with respect to the vertical axis Z. The first driven roller 103 comprises an inner part 1030 with a helical gearing and a sleeve 1031. The second driven roller 104 is formed in one piece and has no gearing. A disc-shaped cover 105 is arranged rotatably around the vertical axis Z around the first driven roller 103 and the second driven roller 104. The cover 105 is essentially flush with a top surface of a top plate 1004 of the roller unit housing 100. The first orientation transmission unit 11 comprises a housing 110 with lateral walls 1100 that are flush with the adjoining lateral walls 1000; 1001 of the first roller unit 10 and a top plate 1101, onto which the housing 100 of the first roller unit 10 rests. A first bore 1102 is provide in the center of the top plate 1101 of the first orientation transmission unit 11, in which the upper part of the cylindrical base 1010 of the retaining bracket 101 is fittingly mounted. The lateral sides of the bracket 101 comprising the arms 1011 rest on the top plate 1101 of the first orientation transmission unit 11. A guide 1103 extending perpendicularly from the top plate 1101 and parallel to a lateral wall 1100 is formed integrally with the top plate 1101 and two opposing lateral walls. The rack 5 abuts the guide 1103 on a side opposite to the cylindrical base 1010 of the retaining bracket 101. The rack 5 protrudes two openings that are arranged in the two opposing lateral walls. The first rotation transmission unit 12 comprises a housing 120 with lateral walls 1200 that are flush with the adjoining lateral walls 1100 of the first orientation transmission unit 11 and a top plate 1201, onto which the housing 110 of the first orientation transmission unit 11 rests. A second bore 1202 is provide in the center of the top plate 1201 of the first rotation transmission unit 12, in which the lower part of the cylindrical base 1010 of the retaining bracket 101 is fittingly mounted. A collar 125 extends perpendicularly from the top plate 1201 concentrically to the second bore 1202 forming a reception for a lower transmission shaft bearing 126. An upper transmission shaft bearing 124 is received on the inside of an upper region of the cylindrical base 1010 of the retaining bracket 101. A first transmission shaft 121 is arranged rotatably about the vertical axis Z in the upper transmission shaft bearing 124 and the lower transmission shaft bearing 126. A bevel wheel 122 is fixed to an upper end of the first transmission shaft 121, which bevel wheel 122 engages the helical gearing of the inner part 1030 of the first driven roller 103. A first pulley 123 is fixed to the first transmission shaft 121 below the lower transmission shaft bearing 126. A first belt 6 engages the first pulley 123. The first drive unit 13 comprises a housing 130 with lateral walls 1300 that are flush with the adjoining lateral walls 1200 of the first rotation transmission unit 12, onto which the housing 120 of the first rotation transmission unit 12 rests and a bottom plate 1301. A collar 135 extends perpendicularly from the bottom plate 1301 concentrically to the vertical axis Z forming a reception for a bearing 136 for a first drive shaft 131. A disc 132 is foxed to an upper part of the first drive shaft 131 and coils 133 with corresponding cores 134 are arranged around the first drive shaft 131. An upper end of the drive shaft 131 is coupled to a lower end of the first transmission shaft 121. The first drive unit 13 affects the rotation of the driven rollers 103; 104, the rack 5 affects rotation of the retaining bracket 101 and the first belt 6 affects the rotation of the driven rollers of a neighboring transfer unit.

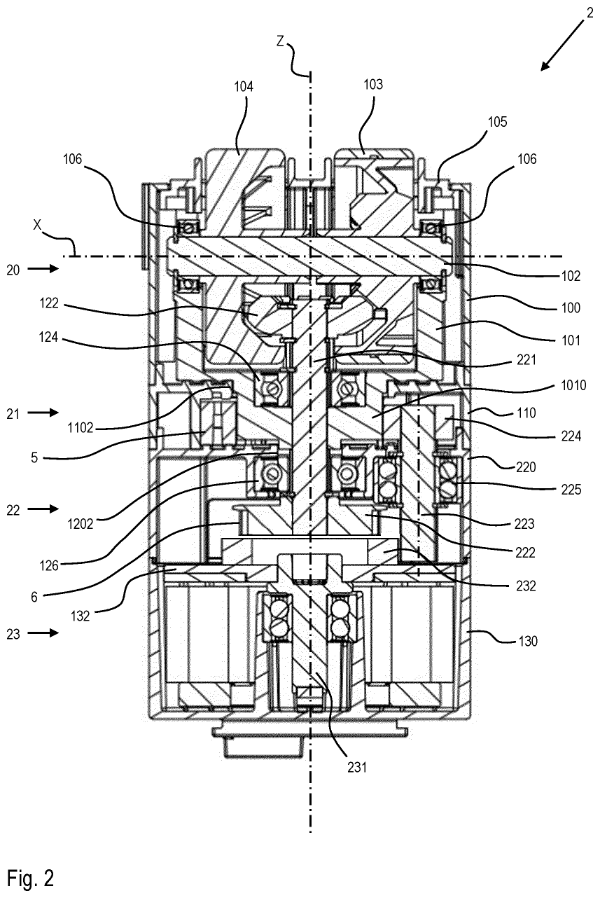

FIG. 2 shows a sectional view of a second transfer unit 2 according to the invention. The elements of the second transfer unit 2 that are identical to the ones of the first transfer unit 1 have identical reference numbers. A second roller unit 20 is stacked atop a second orientation transmission unit 21 that is stacked atop a second rotation transmission unit 22 that is staked atop a second drive unit 23. In contrast to the first transfer unit 1, the second transfer unit 2 comprising a second transmission shaft 221 that is not coupled to a second drive shaft 231 of the second drive unit 23. The second transmission shaft 221 only extends to a second pulley 222 that engages with the first belt 6. The second rotation transmission unit 22 comprises a housing 220 with an additional reception for a bearing 225 for an offset shaft 223, whose axis of rotation is parallel to the one of the second transmission shaft 221. The offset shaft 223 extends from the second rotation transmission unit 22 into the second orientation transmission unit 21. A spur wheel 224 is fixed to an upper end of the offset shaft 223, engaging the gearing of the cylindrical base 1010 of the retaining bracket 101. A lower end of the offset shaft 223 comprises a gearing that engages with a second spur wheel 232 of the second drive unit 23. The second spur wheel 232 is coupled to the second drive shaft 231, directly or by means of the disc 132. The second drive unit 23 affects the rotation of the retaining bracket 101, the rack 5 affects the rotation of the retaining bracket of a neighboring transfer unit and the first belt 6 affects the rotation of the driven rollers 103; 104.

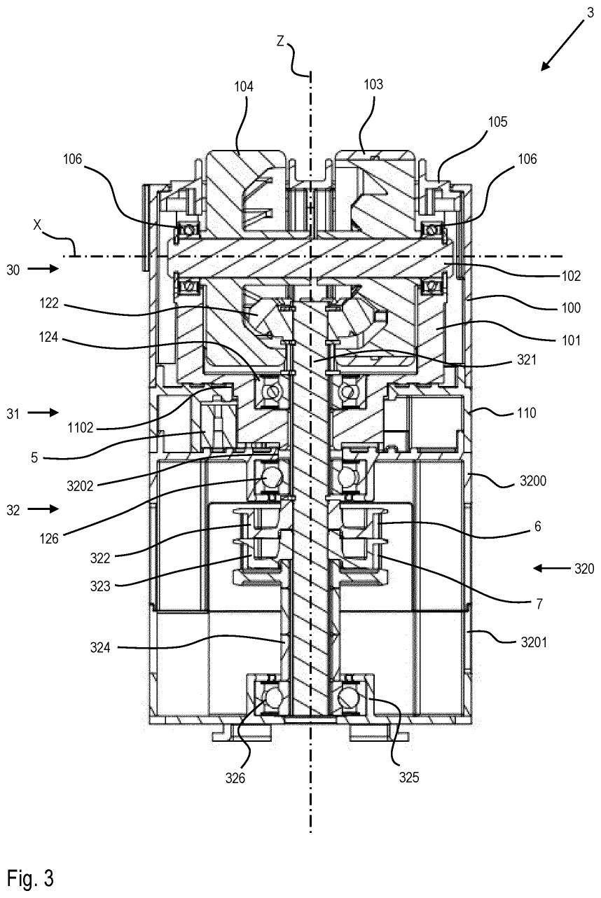

FIG. 3 shows a sectional view of a third transfer unit 3 according to the invention. The elements of the third transfer unit 3 that are identical to the ones of the first transfer unit 1 and the second transfer unit 2 have identical reference numbers. A third roller unit 30 is stacked atop a third orientation transmission unit 31 that is stacked atop a third rotation transmission unit 32. In contrast to the first transfer unit 1 and to the second transfer unit 2, the third transfer unit 3 has no drive unit. The third rotation transmission unit 32 comprises a housing 320 with an upper housing part 3200 and a lower housing part 3201, which together equal to the outer dimensions of the combined housings of the first rotation transmission unit 12 and the first drive unit 13 or the second rotation transmission unit 22 and the second drive unit 23. In a top plate of the upper housing part 3200 a third bore 3202 is provided, corresponding to the second bore 1202 of the first rotation transmission unit 22 or the second rotation transmission unit 32. A collar 325 extends perpendicularly from a bottom plate of the lower housing part 3201 concentrically to the vertical axis Z forming a reception for a lowest bearing 326 for a third transmission shaft 321. A third pulley 322 is fixed to the third transmission shaft 321 adjacent to the lower transmission shaft bearing 126 and a fourth pulley 323 is fixed to the third transmission shaft 321 adjacent to the third pulley 322. A first belt 6 engages the third pulley 322 and a second belt 7 engages the fourth pulley 323. Spacers 324 are arranged between the fourth pulley 323 and the lowest transmission shaft bearing 326. The rack 5 affects the rotation of the retaining bracket 101 and the first belt 6 and the second belt 7 affect the rotation of the driven rollers 103; 104 or the driven rollers of a neighboring transfer unit.

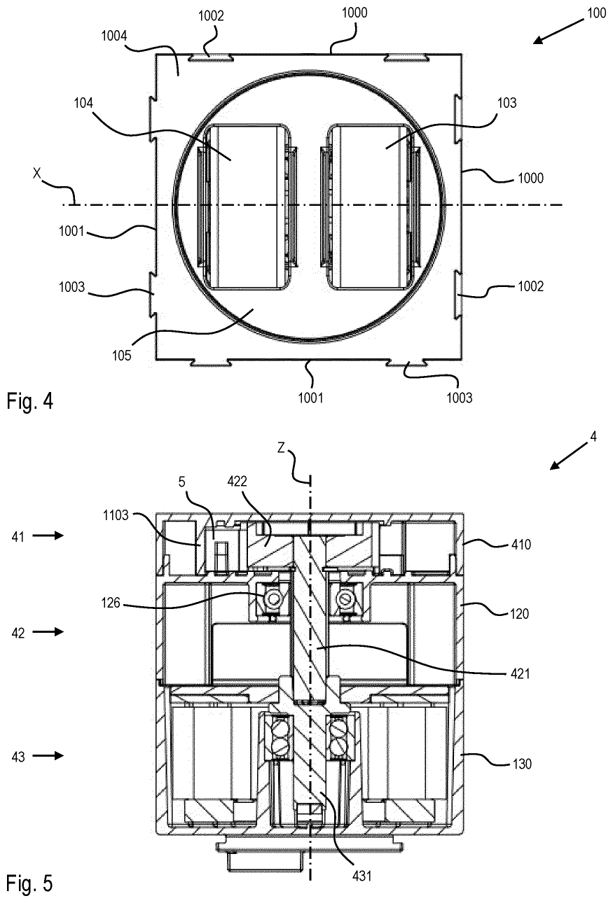

FIG. 4 shows a top view of the first transfer unit 1, the second transfer unit 2 and the third transfer unit 3. Each of the corresponding roller units 10; 20; 30 has a housing 100 with two neighboring first lateral walls 1000 with two recesses 1002 and two neighboring second lateral walls 1001 with two projections 1003 that are complementary to the recesses 1002. There is a circular opening in the top plate 1004 in which the cover 105 is arranged. The Cover 105 has two symmetrically arranged openings through which the first driven roller 103 and the second driven roller 104 protrude.

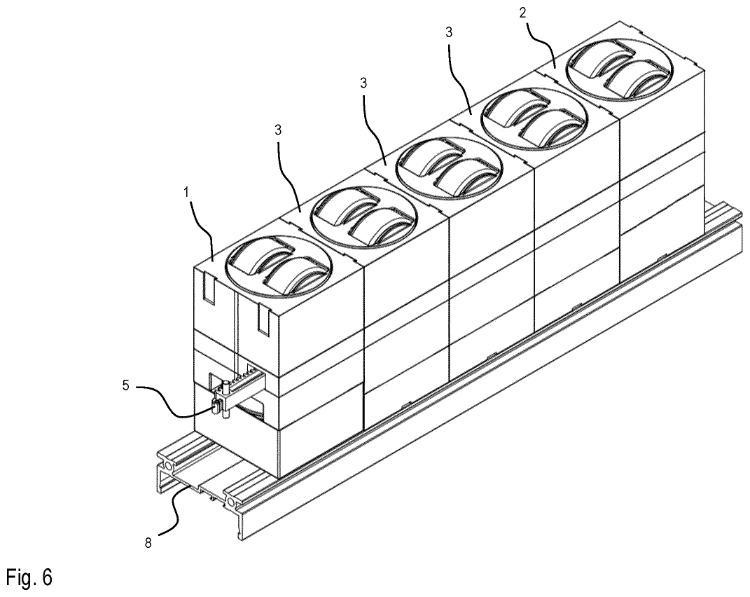

FIG. 5 shows sectional view of a separate drive unit 4. It comprises a fourth orientation transmission unit 41 that is stacked atop a spacer unit 42 that is stacked atop a third drive unit 43. The fourth orientation transmission unit 41 has a housing 410 with a closed top plate. The housing 120 of the spacer unit 42 is identical to the housing of the first rotation transmission unit 12. The third drive unit 43 is identical to the first drive unit 13. A fourth transmission shaft 421 is mounted rotatably around the vertical axis Z in the corresponding lower transmission shaft bearing 126. A lower end of the fourth transmission shaft 421 is coupled to a third drive shaft 431. A third spur wheel 422 is fixed to an upper end of the fourth transmission shaft 421 engaging the rack 5. The rack 5 affects the rotation of the retaining bracket of a neighboring transfer unit.

FIG. 6 shows a perspective view of a first embodiment of a transfer assembly according to the invention. One first transfer unit 1 followed by several third transfer units 3, followed by one second transfer unit 2 are arranged in a single line on a profile 8. The rack 5 extends through all transfer units and synchronizes the rotation of all their retaining brackets. A first belt synchronizes the rotation of the driven roller of the second transfer unit 2 with that of the neighboring third transfer unit 3 and a second belt and alternating a first belt synchronizes the rotation of the driven roller of two neighboring third transfer units 3 or first transfer unit 1.

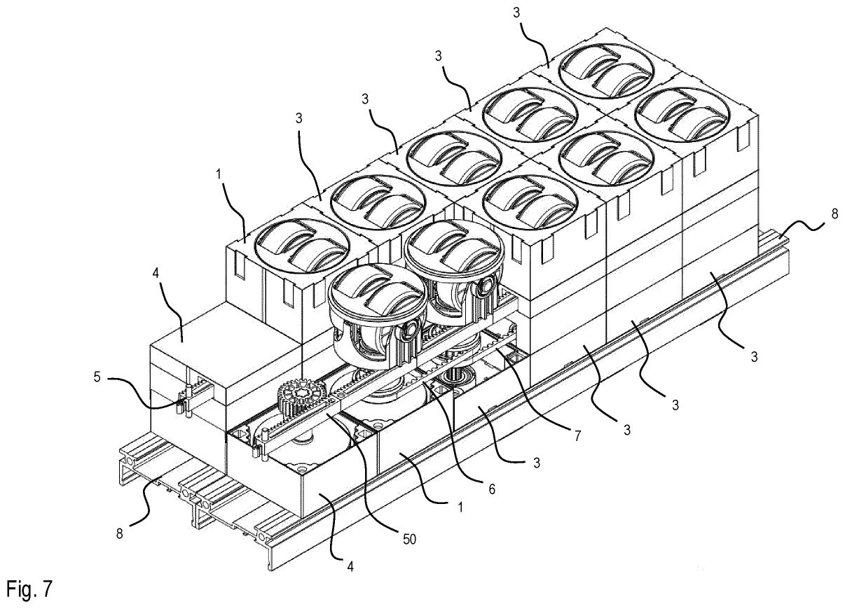

FIG. 7 shows a perspective view of a second embodiment of a transfer assembly according to the invention. One separate drive unit 4 followed by one first transfer unit 1 and several third transfer units 3 are arranged in a first single line on a profile 8. An identical arrangement is provided next to it. The rack 5 comprises several identical rack parts 50 and extends through the separate drive unit 4 and all transfer units. The rack 5 is driven by the separate drive unit 4 and synchronizes the orientation of all the retaining brackets of the transfer units and therefore the orientation of all the corresponding driven rollers. A first belt 6 synchronizes the rotation of the driven rollers of the first transfer unit 1 with that of a neighboring third transfer unit 3. A second belt 7 synchronizes the rotation of the driven rollers of two neighboring third transfer units 3.

REFERENCE SIGNS LIST

| | | | |
|---|---|---|---|
| 1 | first transfer unit | 1201 | top plate |
| 10 | first roller unit | 1202 | second bore |
| 100 | housing | 121 | first transmission |
| 1000 | first lateral wall | | shaft |
| 1001 | second lateral wall | 122 | bevel wheel |
| 1002 | recess | 123 | first pulley |
| 1003 | projection | 124 | upper transmission |
| 1004 | top plate | | shaft bearing |
| 101 | retaining bracket | 125 | collar |
| 1010 | cylindrical base | 126 | lower transmission |
| 1011 | arm | | shaft bearing |
| 102 | roller shaft | 13 | first drive unit |
| 103 | first driven roller | 130 | housing |
| 1030 | inner part | 1300 | lateral wall |
| 1031 | sleeve | 1301 | bottom plate |
| 104 | second driven roller | 131 | first drive shaft |
| 105 | cover | 132 | disc |
| 106 | roller shaft bearing | 133 | coil |
| 11 | first orientation | 134 | core |
| | transmission unit | 135 | collar |
| 110 | housing | 136 | bearing |
| 1100 | lateral wall | 2 | second transfer unit |
| 1101 | top plate | 20 | second roller unit |
| 1102 | first bore | 21 | second orientation |
| 1103 | guide | | transmission unit |
| 12 | first rotation | 22 | second rotation |
| | transmission unit | | transmission unit |
| 120 | housing | 220 | housing |
| 1200 | lateral wall | | |
| 221 | second transmission | 324 | spacer |
| | shaft | 325 | collar |
| 222 | second pulley | 326 | bearing |
| 223 | offset shaft | 4 | separate drive unit |
| 224 | first spur wheel | 41 | fourth orientation |
| 225 | bearing | | transmission unit |
| 23 | second drive unit | 410 | housing |
| 231 | second drive shaft | 42 | spacer unit |
| 232 | second spur wheel | 421 | fourth transmission |
| 3 | third transfer unit | | shaft |
| 30 | third roller unit | 422 | third spur wheel |
| 31 | third orientation | 43 | third drive unit |
| | transmission unit | 431 | third drive shaft |
| 32 | third rotation | 5 | rack |
| | transmission unit | 50 | rack part |
| 320 | housing | 6 | first belt |
| 3200 | upper housing part | 7 | second belt |
| 3201 | lower housing part | 8 | profile |
| 3202 | third bore | | |
| 321 | third transmission | X | horizontal axis |
| | shaft | | |
| 322 | third pulley | Z | vertical axis |
| 323 | fourth pulley | | |

1. A transfer unit (1; 2) comprising:
a roller unit (10) with at least one driven roller (103; 104) that is mounted rotatably about a horizontal axis (X) on a retaining bracket (101),
an orientation transmission unit (11; 21) with a housing (110; 210), in which the retaining bracket (101) is arranged rotatably about a vertical axis (Z),
a rotation transmission unit (12; 22) with a housing (120; 220), in which a transmission shaft (121; 221) is arranged rotatably about the vertical axis (Z), at an upper end of which transmission shaft (121; 221) a bevel wheel (122) is fixed,
wherein the orientation transmission unit (11; 21) is stacked above the rotation transmission unit (12; 22), and wherein the bevel wheel (122) engages the at least one driven roller (103),
characterized in that the transfer unit (1; 2) comprises a drive unit (13; 23) with a housing (130),
in which a drive shaft (131; 231) is arranged rotatably about the vertical axis (Z),
in that the rotation transmission unit (12; 22) is stacked above the drive unit (13; 23) and in that the drive shaft (131) is operatively connected to the transmission shaft (121) for enabling the driving of the at least one driven roller (103) or
in that the drive shaft (231) is operatively connected to the retaining bracket (101) for enabling the adjustment of the orientation of the at least one driven roller (103).

2. The transfer unit according to claim 1, wherein a first transfer unit (1) comprises a first roller unit (10), which is stacked above a first orientation transmission unit (11),
which is stacked above a first rotation transmission unit (12), which is stacked above a first drive unit (13),
wherein a first drive shaft (131) of the first drive unit (13) is directly coupled to a first transmission shaft (121) of the first rotation transmission unit (12), and
wherein a first pulley (123) is arranged in the housing (120) of the first rotation transmission unit (12) and is fixed to the first transmission shaft (121).

3. The transfer unit according to claim 1, wherein a second transfer unit (2) comprises a second roller unit (20), which is stacked above a second orientation transmission unit (21), which is stacked above a second rotation transmission unit (22), which is stacked above a second drive unit (23),
wherein a second drive shaft (231) of the second drive unit (23) is coupled to the retaining bracket (101) of the second roller unit (20) by a first spur wheel (224), an offset shaft (223) and a second spur wheel (232) reaching from the second orientation transmission unit (21) into the second rotation transmission unit (22), and
wherein a second pulley (222) is arranged in the housing (220) of the second rotation transmission unit (22) and is fixed to a second transmission shaft (221).

4. The transfer unit according to claim 1, wherein the at least one driven roller (103) comprises a helical gearing that engages the bevel wheel (122).

5. The transfer unit according to claim 1, wherein a first driven roller (103) and a second driven roller (104) are arranged on a horizontal roller shaft (102), wherein the first driven roller (103) comprises the helical gearing and wherein the second driven roller (104) has no gearing.

6. The transfer unit according to claim 5, wherein the first driven roller (103) and the second driven roller (104) are fixed to the roller shaft (102) or to one another.

7. The transfer unit according to claim 1, wherein the retaining bracket (101) comprises a cylindrical base (1010) that extends along the vertical axis (Z) and two arms (1011) that are attached to the cylindrical base (1010) and that extend in the direction of the vertical axis (Z) on two opposing lateral sides of the cylindrical base (1010).

8. The transfer unit according to claim 7, wherein the cylindrical base (1010) comprises a spur gearing at its circumference, with which a rack (5) can engage.

9. The transfer unit according to claim 5, wherein the roller shaft (102) is mounted on the two arms (1011) with roller shaft bearings (106).

10. The transfer unit according to claim 1, wherein a roller unit housing (100) laterally encloses the retaining bracket (101) and wherein a part of the at least one driven roller (103) protrudes from the roller unit housing (100) and wherein a disc-shaped cover (105) is arranged rotatably around the vertical axis (Z) around the at least one driven roller (103) and flush with a top surface of a top plate (1004) of the roller unit housing (100).

11. The transfer unit according to claim 10, wherein at least one recess (1002) is arranged in first lateral walls (1000) and wherein a corresponding number of thereto complementary projections are arranged on second lateral walls (1001) that are arranged opposite to the first lateral walls (1000).

12. The transfer unit according to claim 1, wherein the housing (110; 210) of the orientation transmission unit (11; 21) comprises a first bore (1102) in which an upper part of the cylindrical base (1010) of the retaining bracket (101) is rotatably arranged, and
wherein the housing (120; 220) of the rotation transmission unit (12; 22) comprises a second bore (1202) in which a lower part of the cylindrical base (1010) of the retaining bracket (101) is rotatably arranged.

13. A transfer assembly comprising:
one first transfer unit (1) according to claim 2,
one second transfer unit (2) comprising a second roller unit (20), which is stacked above a second orientation transmission unit (21), which is stacked above a second rotation transmission unit (22), which is stacked above a second drive unit (23), wherein a second drive shaft (231) of the second drive unit (23) is coupled to the retaining bracket (101) of the second roller unit (20) by a first spur wheel (224), an offset shaft (223) and a second spur wheel (232) reaching from the second orientation transmission unit (21) into the second rotation transmission unit (22), and wherein a second pulley (222) is arranged in the housing (220) of the second rotation transmission unit (22) and is fixed to a second transmission shaft (221), and at least one third transfer unit (3), wherein the first transfer unit (1) is arranged on a first lateral side of the at least one third transfer unit (3) and wherein the second transfer unit (2) is arranged on a second lateral side of the at least one third transfer unit (3), opposite to the first lateral side or comprising:
one first transfer unit (1), at least one third transfer unit (3) and one separate drive unit (4),
wherein the first transfer unit (1) is arranged on a first lateral side of the at least one third transfer unit (3) and wherein the separate drive unit (4) is arranged on a second lateral side of the at least one third transfer unit (3), opposite to the first lateral side or wherein the separate drive unit (4) is arranged on a side of the first transfer unit (1), opposite to the at least one third transfer unit (3),
wherein the third transfer unit (3) comprises a third roller unit (30), which is stacked above a third orientation transmission unit (31), which is stacked above a third rotation transmission unit (32),
wherein a third pulley (322) and a fourth pulley (323) are arranged in a housing (320) of the third rotation transmission unit (32) and are fixed to a third transmission shaft (321),
wherein the separate drive unit (4) comprises a fourth orientation transmission unit (41), which is stacked above a spacer unit (42), which is stacked above a third drive unit (43),
wherein the spacer unit (42) comprises a housing (420), in which a fourth transmission shaft (421) is arranged rotatably about the vertical axis (Z), at an upper end of which fourth transmission shaft (421) a third spur wheel (422) is fixed,
wherein a third drive shaft (431) of the third drive unit (43) is directly coupled to the fourth transmission shaft (421) of the spacer unit (42),
wherein a first belt (6) is wrapped around the first pulley (123) of the first transfer unit (1) and around the third pulley (322) of the third transfer unit (3), or
wherein the first belt (6) is wrapped around the second pulley (222) of the second transfer unit (2) and around the third pulley (322) of the third transfer unit (3),
wherein a second belt (7) is wrapped around the fourth pulley (323) of two neighboring third transfer units (3),
wherein a common rack (5) is arranged linearly movable in the first orientation transmission unit (11) of the first transfer unit (1), the second orientation transmission unit (21) of the second transfer unit (2) and the third orientation transmission unit (31) of the third transfer unit (3), or wherein the common rack (5) is arranged linearly movable in the first orientation transmission unit (11) of the first transfer unit (1), the third orientation transmission unit (31) of the third transfer unit (3) and the fourth orientation transfer unit (41) of the separate drive unit (4).

14. The transfer assembly according to claim 13, wherein the common rack (5) comprises several identical rack parts (50) that are connected to one another in a single line, wherein each rack part (50) has a length of one transfer unit in the direction of the linear movement of the common rack (5).

15. A transfer arrangement comprising at least two transfer assemblies according to claim 14 which are arranged next to each other in a first horizontal direction or in a first horizontal direction and a second horizontal direction, perpendicular to the first horizontal direction.
